(19) United States
(12) Patent Application Publication
(10) Pub. No.: US 2021/0209160 A1
(43) Pub. Date: Jul. 8, 2021

(54) METHOD AND APPARATUS FOR IDENTIFYING MAP REGION WORDS

(71) Applicant: BEIJING BAIDU NETCOM SCIENCE AND TECHNOLOGY CO., LTD., Beijing (CN)

(72) Inventors: Yanyan Li, Beijing (CN); Jianguo Duan, Beijing (CN)

(73) Assignee: BEIJING BAIDU NETCOM SCIENCE AND TECHNOLOGY CO., LTD., Beijing (CN)

(21) Appl. No.: 17/211,193

(22) Filed: Mar. 24, 2021

(30) Foreign Application Priority Data
Sep. 25, 2020 (CN) 202011027587.7

(51) Int. Cl. G06F 16/906; G01C 21/36; G01C 21/00; H04W 4/029; G06F 16/909; H04W 4/021

(52) U.S. Cl. CPC G06F 16/906; G01C 21/3679; H04W 4/021; H04W 4/029; G06F 16/909; G01C 21/3811

(57) ABSTRACT

A method and an apparatus for identifying map region words are disclosed. The method includes: obtaining points of interest POI data in the map; determining at least one text word in the POI data as a target word, and performing clustering processing according to location information of some pieces of the POI data to which the target word belongs; and identifying whether the target word is a map region word according to the clustering result of the location information.

### CROSS-REFERENCE TO RELATED APPLICATION

The present application is based upon and claims priority to Chinese Patent Application No. 202011027587.7, filed on Sep. 25, 2020, the entire contents of which are incorporated herein by reference.

### TECHNICAL FIELD

The present disclosure relates to a field of artificial intelligence, in particular to big data and intelligent transportation technologies, and in particular to a method and an apparatus for identifying map region words, an electronic device and a storage medium.

### BACKGROUND

As a component of the map, region words are very important for related applications such as a map and a location based services (LBS).

At present, region words are mainly identified by uploading user generated contents (UGC), collecting professionally generated contents (PGC) and crawling webs.

However, there are some shortcomings in the related art, such as high dependence on user enthusiasm, high labor cost and low coverage rate of region word identifying results.

### SUMMARY

According to a first aspect, a method for identifying map region words is provided. The method includes: obtaining points of interest (POI) data in the map; determining at least one text word in the POI data as a target word, and performing clustering processing according to location information of some pieces of the POI data to which the target word belongs; and identifying the target word from the map region words according to the clustering result of the location information.

According to a second aspect, an apparatus for identifying map region words is provided. The apparatus includes at least one processor and a memory communicatively coupled to the at least one processor. The at least one processor is configured to obtain POI data in the map; determine at least one text word in the POI data as a target word, and perform clustering processing according to location information of some pieces of the POI data to which the target word belongs; and identify whether the target word is a map region word according to the clustering result of the location information.

According to a third aspect, a non-transitory computer-readable storage medium having computer instructions stored thereon is provided. The computer instructions are configured to cause a computer to execute a method for identifying map region words. The method includes: obtaining points of interest (POI) data in the map; determining at least one text word in the POI data as a target word, and performing clustering processing according to location information of some pieces of the POI data to which the target word belongs; and identifying the target word from the map region words according to the clustering result of the location information.

It should be understood that, the content described in this section is not intended to identify key or important features of the embodiments of the present disclosure, nor is intended to limit the scope of the present disclosure. Other features of the present disclosure will be easily understood through the following description.

### BRIEF DESCRIPTION OF THE DRAWINGS

The drawings are used to better understand the solution and do not constitute a limitation to the present disclosure, wherein:

FIG. 1 is a schematic flowchart of a method for identifying map region words according to an embodiment of the present disclosure.

FIG. 2 is a schematic flowchart of a method for identifying map region words according to an embodiment of the present disclosure.

FIG. 3 is a schematic flowchart of a method for identifying map region words according to an embodiment of the present disclosure.

FIG. 4 is a structural schematic diagram of an apparatus for identifying map region words according to an embodiment of the present disclosure.

FIG. 5 is a block diagram of an electronic device configured to implement the method for identifying map region words according to an embodiment of the present disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

FIG. 1 is a schematic flowchart of a method for identifying map region words according to an embodiment of the present disclosure. This embodiment may be applied to a server that identifies region words from an existing point of interest (POI) data in a map and uses the identified region words in applications related to maps. The method may be executed by an apparatus for identifying map region words. The apparatus is implemented in software and/or hardware, and is preferably configured in an electronic device, such as a server.

Referring to FIG. 1, the method for identifying map region words is as follows.

At block S101, points of interest POI data is obtained in the map.

Optionally, a total amount of POI data is obtained from a map database. Each piece of POI data may include information such as a POI name, a location, a category, nearby hotels, restaurants and shops, etc.

At block S102, at least one text word in the POI data is determined as a target word, and clustering processing is performed according to location information of some pieces of the POI data to which the target word belongs.

In the embodiment of the present disclosure, when a region word to be identified (i.e., a target word) in the POI data is determined since a region is a component of the POI name, a text word corresponding to the POI name in the POI data is optionally determined as the target word, or at least one text word in the obtained word segmentation result is optionally determined as the target word after word segmentation processing is first performed on the POI name in the POI data.

The location information may optionally be the latitude and longitude of the POI. The POI data to which the target word belongs refers to the POI data whose POI name includes the target word. After the target word is obtained, the POI data whose POI name includes the target word may be thus determined from the total amount of POI data, thereby obtaining the location information of some pieces of the POI data containing the target word. Since there may be multiple pieces of POI data whose POI name includes the target word, there are also multiple pieces of location information of the POI data to which the target word belongs. The clustering processing may be then performed on the location information of some pieces of the POI data to which the target word belongs.

In an alternative implementation, performing clustering processing according to the location information of some pieces of the POI data to which the target word belongs includes: performing clustering processing on the location information of some pieces of the POI data to which the target word belongs with a density-based clustering algorithm. The specific clustering process is described as the following steps. At step 1, a radius r and a minimum number threshold are determined. Starting from an arbitrary location information point that has not been visited before, this point is taken as a center to form a circle with the radius r. It is then determined whether a number of location information points contained in the circle is greater than or equal to the minimum number threshold. This location information point will be marked as a core point if the number of location information points contained in the circle is greater than or equal to the minimum number threshold, otherwise it will be marked as a noise point. At step 2, the operation of step 1 is repeated. If a noise point exists in a circle with the core point, this point is marked as an edge point, otherwise it is still a noise point. The above steps are repeated until all the location information points have been visited. In this way, the clustering result may be obtained. It should be noted that the reason why the density-based clustering algorithm is selected is that, the clustering speed is so fast that noise points may be effectively treated and spatial clusters of arbitrary shapes may be found.

At block S103, it is identified whether the target word is a map region word according to the clustering result of the location information.

In an alternative implementation, identifying whether the target word is the map region word according to the clustering result of the location information includes: obtaining a number of clustering centers in the clustering result, and determining the target word as the map region word in response to the number of clustering centers being not greater than a second preset number threshold. Exemplarily, the second preset number threshold is 3 or other values, which is not limited in particular herein. It should be noted that, the efficiency and accuracy of determining the region words may be improved by determining whether a target word is a region word or not according to the number of clustering centers in the clustering result.

Exemplarily, when the target word is “Shangdi”, the number of clusters is obtained and determined as 1 (that is, one clustering center) after the location information of some pieces of POI data whose POI names include “Shangdi” is clustered, then the target word “Shangdi” is considered as a region word. For another example, when the target word is “food”, the number of clusters is obtained and determined as hundreds or thousands after the location information of some pieces of POI data whose POI names include “food” is clustered. That is, there are hundreds or thousands of clustering centers. This word is not considered as a region word.

In the embodiment of the present disclosure, the target word is determined in the POI data, the location information of some pieces of the POI data to which the target word belongs is clustered, and the region word is identified according to the clustering result. In this way, it is achieved that the region words are identified directly in the existing POI data, thereby avoiding manual determination of region words and improving the efficiency of identifying the region words. In addition, the obtained region words are more comprehensive by mining the region words with all the POI data compared to a crawling technology for crawling the region words.

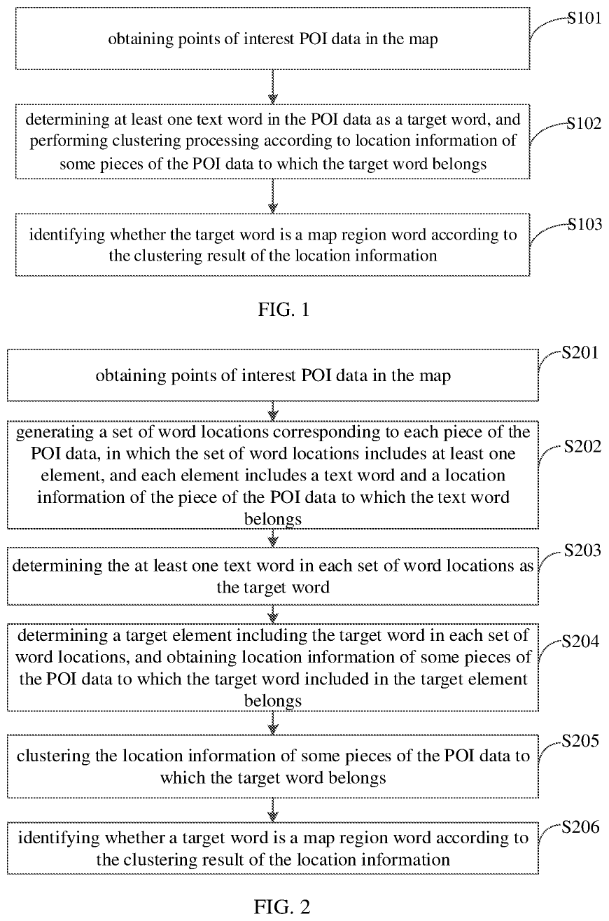

FIG. 2 is a schematic flowchart of a method for identifying map region words according to an embodiment of the present disclosure. This embodiment is optimized on the basis of the above-mentioned embodiment. Referring to FIG. 2, the method for identifying map region words is specifically as the following blocks S201-S206.

At block S201, points of interest POI data is obtained in the map.

At block S202, a set of word locations is generated corresponding to each piece of the POI data. The set of word locations includes at least one element. Each element includes a text word and a location information of the piece of the POI data to which the text word belongs.

In an alternative implementation, generating the set of word locations corresponding to each piece of the POI data includes the following blocks S2021-S2023.

At block S2021, a POI name and location information of the piece of the POI data is obtained for any piece of the POI data.

Optionally, after the POI name and location information of each piece of the POI data are obtained from the total amount of POI data, a set of POI data is generated, P={(n₀, l₀), (n₁, l₁), . . . (nᵢ, lᵢ) . . . , (nₙ, lₙ)}, where n is equal to the total amount of POI data obtained, nᵢ represents the POI name and lᵢ represents the location information of the piece of the POI data with a name of nᵢ.

At block S2022, word segmentation processing is performed on the POI name to obtain at least one text word.

There are a plurality of words in the POI name. In order to identify more region words, the word segmentation is optionally performed on any POI name in the set of POI data to obtain at least one text word. Exemplarily, for any element Pᵢ in the set P, nᵢ is taken and word segmentation processing is performed to obtain a set of word segmentations, (w₀, w₁, . . . wₖ), where k represents a number of words obtained after segmenting the nᵢ.

At block S2023, the set of word locations corresponding to the piece of POI data is generated based on at least one text word and the location information.

Exemplarily, for any element Pᵢ in the set P, the set of word locations Wᵢ={(w₀, lᵢ),(w₁,lᵢ), . . . (wₖ,lᵢ)} corresponding to the element Pᵢ is constructed with all the words obtained after the segmentation and the location of the POI. It can be seen that the set of word locations corresponding to each piece of POI data includes at least one element, and each element includes a text word and a location information of the piece of the POI data to which the text word belongs.

It should be noted that, at least one text word is obtained by segmenting the POI name of each piece of the POI data, which can ensure that sufficient target words are mined, thereby ensuring to identify whether more region words are the target words and ensuring the coverage rate of region words. Furthermore, constructing the set of word locations corresponds to establishing a mapping relationship between the text word and the location information of some pieces of the POI data to which the text word belongs, so that after a certain text word is determined as the target word, the location information of some pieces of the POI data to which the target word belongs can be quickly determined.

At block S203, at least one text word in each set of word locations is determined as a target word.

Optionally, any one or more text words can be directly determined as target words.

It should be noted that, as there are some text words obviously being not region words in the set, these text words can be filtered out before the target word is determined. For example, these text words can be filtered out through a preset non-region word database.

At block S204, a target element including the target word is determined in each set of word locations, and it is obtained that the location information of some pieces of the POI data to which the target word included in the target element belongs.

After determining the target word, the target element including the target word is determined in each set of word locations. That is, it is determined that all the POI data whose POI names include the target word. Since the location information of some pieces of the POI data to which the target word belongs is recorded in the target element, the obtained location information of some pieces of the POI data of the target word belongs may be formed as a set. For example, a set of locations L_{w}_{ᵢ}={lⱼ|j=0, 1, . . . m} is constructed, where m is a number of locations of the POI containing the target word wᵢ, that is, a number of target elements.

At block S205, it is clustered that the location information of some pieces of the POI data to which the target word belongs.

Optionally, clustering processing is performed on the location information of some pieces of the POI data to which the target word belongs with a density-based clustering algorithm. The specific process may refer to the above-mentioned embodiment, which will not be repeated herein.

It should be noted that, a set of word locations is constructed, and the location information of some pieces of the POI data to which the target word included in the target element belongs is obtained from each set of word locations, thereby improving the efficiency of obtaining the location information of some pieces of the POI data to which the target word belongs and improving the subsequent clustering efficiency.

At block S206, it is identified whether the target word is a map region word according to the clustering result of the location information.

In the embodiment of the present disclosure, the determined target word and the location information of some pieces of the POI data to which the target word belongs may be quickly obtained from the set of word locations by constructing the set of word locations, thereby ensuring the subsequent clustering efficiency and improving the efficiency of identifying the region words.

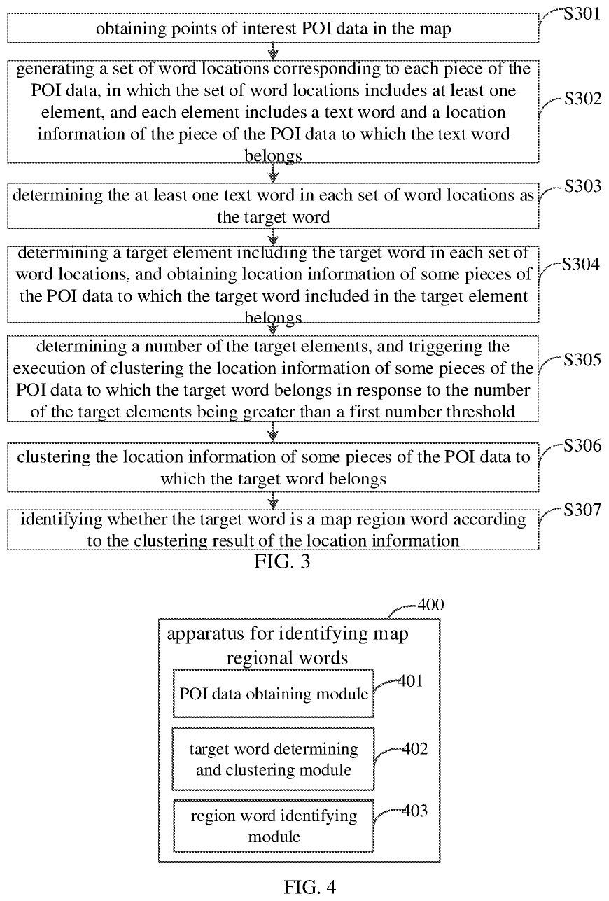

FIG. 3 is a schematic flowchart of a method for identifying map region words according to an embodiment of the present disclosure. This embodiment is optimized on the basis of the above-mentioned embodiment. Referring to FIG. 3, the method for identifying map region words is specifically as the following blocks S301-S307.

At block 301, points of interest POI data is obtained in the map.

At block S302, a set of word locations is generated corresponding to each piece of the POI data. The set of word locations includes at least one element. Each element includes a text word and a location information of the piece of the POI data to which the text word belongs.

At block S303, at least one text word in each set of word locations is determined as a target word.

At block S304, a target element that includes the target word is determined in each set of word locations, and it is obtained that location information of some pieces of the POI data to which the target word included in the target element belongs.

At block S305, a number of the target elements is determined, and the execution of clustering the location information of some pieces of the POI data to which the target word belongs is triggered in response to the number of the target elements being greater than a first number threshold.

In the embodiment of the present disclosure, the reason for determining the number of target elements is that, when the number of target elements is too small, indicating that there are small pieces of POI data whose POI name includes the target word, the target word is definitely not a region word, so there is no need for the subsequent clustering operation. Therefore, in order to ensure the effectiveness of the subsequent clustering operation, it is necessary to trigger the execution of clustering the location information of some pieces of the POI data to which the target word belongs when the number of target elements is greater than the first number threshold.

At block S306, it is clustered that the location information of some pieces of the POI data to which the target word belongs.

At block S307, it is identified whether the target word is a map region word according to the clustering result of the location information.

Optionally, the number of clustering centers in the clustering result is obtained, and the target word is determined as the map region word in response to the number of clustering centers being not greater than a second preset number threshold.

In the embodiment of the present disclosure, the number of target elements is determined, and the execution of clustering the location information of some pieces of the POI data to which the target word belongs is triggered in response to the number of the target elements being greater than a first number threshold, thereby ensuring the effectiveness of the clustering operation.

FIG. 4 is a structural schematic diagram of an apparatus for identifying map region words according to an embodiment of the present disclosure. This embodiment may be applied to a server that identifies region words from an existing point of interest (POI) data in a map and uses the identified region words in applications related to maps. As illustrated in FIG. 4, the apparatus 400 specifically includes a POI data obtaining module 401, a target word determining and clustering module 402 and a region word identifying module 403.

The POI data obtaining module 401 is configured to obtain points of interest (POI) data in the map.

The target word determining and clustering module 402 is configured to determine at least one text word in the POI data as a target word, and perform clustering processing according to location information of some pieces of the POI data to which the target word belongs.

The region word identifying module 403 is configured to identify whether the target word is a map region word according to the clustering result of the location information.

Based on the above embodiment, optionally, the target word determining and clustering module includes a set of word locations generating unit and target word determining unit.

The set of word locations generating unit is configured to generate a set of word locations corresponding to each piece of the POI data. The set of word locations includes at least one element, and each element includes a text word and a location information of the piece of the POI data to which the text word belongs.

The target word determining unit is configured to determine the at least one text word in each set of word locations as the target word.

Based on the above embodiment, optionally, the target word determining and clustering module includes a target element determining unit and a clustering unit.

The target element determining unit is configured to determine a target element including the target word in each set of the word locations, and obtain the location information of some pieces of the POI data to which the target word included in the target element belongs.

The clustering unit is configured to cluster the location information of some pieces of the POI data to which the target word belongs.

Based on the above embodiment, optionally, the set of word locations unit is specifically configured to: obtain a POI name and location information of the piece of the POI data for any piece of the POI data; perform word segmentation processing on the POI name to obtain at least one text word;

and generate the set of word locations corresponding to the piece of the POI data based on at least one text word and the location information.

Based on the above embodiment, optionally, the apparatus further includes a triggering module.

The trigger module is configured to before clustering the location information of some pieces of the POI data to which the target word belongs, determine a number of the target elements and trigger the execution of clustering the location information of some pieces of the POI data to which the target word belongs in response to the number of the target elements being greater than a first number threshold.

Based on the above embodiment, optionally, the region word identifying module is specifically configured to: obtain a number of clustering centers in the clustering result, and determine the target word as the map region word in response to the number of clustering centers being not greater than a second preset number threshold.

Based on the above embodiment, optionally, the target word determining and clustering module is further configured to perform clustering processing on the location information of the POI data to which the target word belongs with a density-based clustering algorithm.

The method for identifying map region words according to any embodiment of the present disclosure may be executed by the apparatus 400 for identifying map region words according to the embodiment of the present disclosure, having the corresponding functional modules with beneficial effects. The content not described in detail in the embodiment may refer to the description in any method embodiment of the present disclosure.

According to the embodiments of the present disclosure, an electronic device and a readable storage medium are also provided.

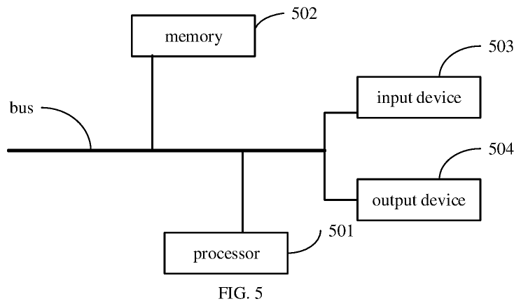

As illustrated in FIG. 5, it is a block diagram of an electronic device configured to implement the method for identifying map region words according to an embodiment of the present disclosure. The electronic device aims to represent various forms of digital computers, such as a laptop computer, a desktop computer, a workstation, a personal digital assistant, a server, a blade server, a mainframe computer and other suitable computers. The electronic device may also represent various forms of mobile devices, such as a personal digital processing, a cellular phone, a smart phone, a wearable device and other similar computing devices. The components, connections and relationships of the components, and functions of the components illustrated herein are merely as examples, and are not intended to limit the implementation of the present disclosure described and/or claimed herein.

As illustrated in FIG. 5, the electronic device includes: one or more processors 501, a memory 502, and interfaces for connecting various components, including a high-speed interface and a low-speed interface. Various components are connected to each other by different buses, and may be mounted on a common main board or mounted in other ways as required. The processor may execute instructions executed within the electronic device, including instructions stored in or on the memory to display graphical information of the GUI (graphical user interface) on an external input/output device (such as a display device coupled to an interface). In other implementations, multiple processors and/or multiple buses may be used together with multiple memories if desired. Similarly, multiple electronic devices may be connected, and each device provides some necessary operations (for example, as an array of servers, a group of blade servers, or a multiprocessor system). In FIG. 5, a processor 501 is taken as an example.

The memory 502 is a non-transitory computer readable storage medium according to the present disclosure. The memory 502 is configured to store instructions executable by at least one processor, the at least one processor is caused to execute a method for identifying map region words according to the present disclosure. The non-transitory computer readable storage medium according to the present disclosure is configured to store computer instructions. The computer instructions are configured to cause a computer to execute the method for identifying map region words according to the present disclosure.

As the non-transitory computer readable storage medium, the memory 502 may be configured to store non-transitory software programs, non-transitory computer executable programs and modules, such as program instructions/modules (such as, the POI data obtaining module 401, the target words determining and clustering module 402 and the region words identifying module 403 as illustrated in FIG. 4) corresponding to the method for identifying map region words according to embodiments of the present disclosure. The processor 501 executes various functional applications and data processing of the server by operating non-transitory software programs, instructions and modules stored in the memory 502, that is, implements the method for identifying map region words according to the above method embodiment.

The memory 502 may include a storage program region and a storage data region. The storage program region may store an application required by an operating system and at least one function. The storage data region may store data created according to usage of the electronic device configured to implement the method for identifying map region words according to the embodiments of the present disclosure. In addition, the memory 502 may include a high-speed random access memory, and may also include a non-transitory memory, such as at least one disk memory device, a flash memory device, or other non-transitory solid-state memory devices. In some embodiments, the memory 502 may optionally include memories remotely located to the processor 501, and these remote memories may be connected via a network to the electronic device configured to implement the method for identifying map region words according to the embodiments of the present disclosure. Examples of the above network include, but are not limited to, the Internet, an intranet, a local area network, a mobile communication network and combinations thereof.

The electronic device configured to implement the method for identifying map region words according to the embodiments of the present disclosure may also include: an input device 503 and an output device 504. The processor 501, the memory 502, the input device 503, and the output device 504 may be connected through a bus or in other means. In FIG. 5, the bus is taken as an example.

The input device 503 may receive inputted digital or character information, and generate key signal input related to user setting and function control of the electronic device configured to implement the method for identifying map region words according to the embodiments of the present disclosure, such as a touch screen, a keypad, a mouse, a track pad, a touch pad, an indicator stick, one or more mouse buttons, a trackball, a joystick and other input device. The output device 504 may include a display device, an auxiliary lighting device (e.g., LED), a haptic feedback device (e.g., a vibration motor), and the like. The display device may include, but be not limited to, a liquid crystal display (LCD), a light emitting diode (LED) display, and a plasma display. In some embodiments, the display device may be the touch screen.

The various implementations of the system and technologies described herein may be implemented in a digital electronic circuit system, an integrated circuit system, an application specific ASIC (application specific integrated circuit), a computer hardware, a firmware, a software, and/or combinations thereof. These various implementations may include: being implemented in one or more computer programs. The one or more computer programs may be executed and/or interpreted on a programmable system including at least one programmable processor. The programmable processor may be a special purpose or general purpose programmable processor, may receive data and instructions from a storage system, at least one input device, and at least one output device, and may transmit the data and the instructions to the storage system, the at least one input device, and the at least one output device.

These computing programs (also called programs, software, software applications, or codes) include machine instructions of programmable processors, and may be implemented by utilizing high-level procedures and/or object-oriented programming languages, and/or assembly/machine languages. As used herein, the terms “machine readable medium” and “computer readable medium” refer to any computer program product, device, and/or apparatus (such as, a magnetic disk, an optical disk, a memory, a programmable logic device (PLD)) for providing machine instructions and/or data to a programmable processor, including machine readable medium that receives machine instructions as a machine readable signal. The term “machine readable signal” refers to any signal for providing the machine instructions and/or data to the programmable processor.

To provide interaction with a user, the system and technologies described herein may be implemented on a computer. The computer has a display device (such as, a CRT (cathode ray tube) or a LCD (liquid crystal display) monitor) for displaying information to the user, a keyboard and a pointing device (such as, a mouse or a trackball), through which the user may provide the input to the computer. Other types of devices may also be configured to provide interaction with the user. For example, the feedback provided to the user may be any form of sensory feedback (such as, visual feedback, auditory feedback, or tactile feedback), and the input from the user may be received in any form (including acoustic input, voice input or tactile input).

The system and technologies described herein may be implemented in a computing system including a background component (such as, a data server), a computing system including a middleware component (such as, an application server), or a computing system including a front-end component (such as, a user computer having a graphical user interface or a web browser through which the user may interact with embodiments of the system and technologies described herein), or a computing system including any combination of such background component, the middleware components, or the front-end component. Components of the system may be connected to each other through digital data communication in any form or medium (such as, a communication network). Examples of the communication network include a local area network (LAN), a wide area network (WAN), the Internet and a blockchain network.

The computer system may include a client and a server. The client and the server are generally remote from each other and usually interact via the communication network. A relationship between the client and the server is generated by computer programs operated on a corresponding computer and having a client-server relationship with each other. The server may be a cloud server, also known as a cloud computing server or a cloud host. It is a host product in the cloud computing service system to solve the defects that traditional physical hosts and VPS services have difficult management and weak business scalability.

According to the technical solution of the embodiments of the present disclosure, it is achieved that region words are identified without manually uploading, thereby improving the coverage rate of region word identifying results.

It should be understood that, steps may be reordered, added or deleted by utilizing flows in various forms illustrated above. For example, the steps described in the present disclosure may be executed in parallel, sequentially or in different orders, so long as desired results of the technical solution disclosed in the present disclosure may be achieved, which is not limited here.

Artificial intelligence is a discipline in which computers are used to simulate certain mental processes and intelligent behaviors (such as learning, reasoning, thinking, planning, etc.) of human, with both of hardware technologies and software technologies. The artificial intelligence hardware technologies generally include technologies such as sensors, dedicated artificial intelligence chips, cloud computing, distributed storage and big data processing. The artificial intelligence software technologies mainly include a computer vision technology, a speech recognition technology, a natural language processing technology, as well as several major directions such as machine/depth learning, a big data processing technology and a knowledge graph technology.

The above detailed implementations do not limit the protection scope of the present disclosure. It should be understood by the skilled in the art that various modifications, combinations, sub-combinations and substitutions may be made based on design requirements and other factors. Any modification, equivalent substitution and improvement made within the spirit and the principle of the present disclosure shall be included in the protection scope of present disclosure.

What is claimed is:

1. A method for identifying map region words, comprising:
obtaining points of interest (POI) data in the map;
determining at least one text word in the POI data as a target word, and performing clustering processing according to location information of some pieces of the POI data to which the target word belongs; and
identifying whether the target word is a map region word according to a clustering result of the location information.

2. The method of claim 1, wherein determining the at least one text word in the POI data as the target word comprises:
generating a set of word locations corresponding to each piece of the POI data, in which the set of word locations includes at least one element, and each element includes a text word and location information of the piece of the POI data to which the text word belongs; and
determining the at least one text word in each set of word locations as the target word.

3. The method of claim 2, wherein performing clustering processing according to the location information of some pieces of the POI data to which the target word belongs comprises:
determining a target element including the target word in each set of word locations, and obtaining the location information of some pieces of the POI data to which the target word included in the target element belongs; and
clustering the location information of some pieces of the POI data to which the target word belongs.

4. The method of claim 2, wherein generating the set of word locations corresponding to each piece of the POI data comprises:
for any piece of the POI data, obtaining a POI name and location information of the piece of the POI data;
performing word segmentation processing on the POI name to obtain at least one text word; and
generating the set of word locations corresponding to the piece of the POI data based on at least one text word and the location information.

5. The method of claim 3, wherein before clustering the location information of some pieces of the POI data to which the target word belongs, the method further comprises:
determining a number of the target elements, and
triggering the execution of clustering the location information of some pieces of the POI data to which the target word belongs in response to the number of the target elements being greater than a first number threshold.

6. The method of claim 1, wherein identifying whether the target word is the map regional word according to the clustering result of the location information comprises:
obtaining a number of clustering centers in the clustering result, and
determining the target word as the map region word in response to the number of clustering centers being not greater than a second preset number threshold.

7. The method of claim 1, wherein performing clustering processing according to location information of some pieces of the POI data to which the target word belongs comprises:
performing clustering processing on the location information of some pieces of the POI data to which the target word belongs with a density-based clustering algorithm.

8. An apparatus for identifying map region words, comprising:
at least one processor; and
a memory communicatively coupled to the at least one processor;
wherein the at least one processor is configured to obtain points of interest (POI) data in the map;
determine at least one text word in the POI data as a target word, and perform clustering processing according to location information of some pieces of the POI data to which the target word belongs; and
identify whether the target word is a region word according to the clustering result of the location information.

9. The apparatus of claim 8, wherein the at least one processor is further configured to:
generate a set of word locations corresponding to each piece of the POI data, in which the set of word locations includes at least one element, and each element includes a text word and a location information of the piece of the POI data to which the text word belongs; and
determine the at least one text word in each set of word locations as the target word.

10. The apparatus of claim 9, wherein the at least one processor is further configured to:
determine a target element including the target word in each set of the word locations, and obtain the location information of some pieces of the POI data to which the target word included in the target element belongs; and
cluster the location information of some pieces of the POI data to which the target word belongs.

11. The apparatus of claim 9, wherein the at least one processor is further configured to:
for any piece of the POI data, obtain a POI name and location information of the piece of the POI data for any POI data;
perform word segmentation processing on the POI name to obtain at least one text word; and
generate the set of word locations corresponding to the piece of the POI data based on at least one text word and the location information.

12. The apparatus of claim 10, wherein the at least one processor is further configured to:
before clustering the location information of the POI data to which the target word belongs, determine a number of the target elements and trigger the execution of clustering the location information of some pieces of the POI data to which the target word belongs in response to the number of the target elements being greater than a first number threshold.

13. The apparatus of claim 8, wherein the wherein the at least one processor is further configured to:
obtain a number of clustering centers in the clustering result, and
determine the target word as the map region word in response to the number of clustering centers being not greater than a second preset number threshold.

14. The apparatus of claim 8, wherein the wherein the at least one processor is further configured to:
perform clustering processing on the location information of some pieces of the POI data to which the target word belongs with a density-based clustering algorithm.

15. A non-transitory computer-readable storage medium having computer instructions stored thereon, wherein the computer instructions are configured to cause a computer to execute a method for identifying map region words, the method comprising:
obtaining points of interest (POI) data in the map;
determining at least one text word in the POI data as a target word, and performing clustering processing according to location information of some pieces of the POI data to which the target word belongs; and
identifying whether the target word is a map region word according to a clustering result of the location information.

16. The storage medium of claim 15, wherein determining the at least one text word in the POI data as the target word comprises:
generating a set of word locations corresponding to each piece of the POI data, in which the set of word locations includes at least one element, and each element includes a text word and location information of the piece of the POI data to which the text word belongs; and
determining the at least one text word in each set of word locations as the target word.

17. The storage medium of claim 16, wherein performing clustering processing according to the location information of some pieces of the POI data to which the target word belongs comprises:
determining a target element including the target word in each set of word locations, and obtaining the location information of some pieces of the POI data to which the target word included in the target element belongs; and
clustering the location information of some pieces of the POI data to which the target word belongs.

18. The storage medium of claim 16, wherein generating the set of word locations corresponding to each piece of the POI data comprises:
for any piece of the POI data, obtaining a POI name and location information of the piece of the POI data;
performing word segmentation processing on the POI name to obtain at least one text word; and
generating the set of word locations corresponding to the piece of the POI data based on at least one text word and the location information.

19. The storage medium of claim 17, wherein before clustering the location information of some pieces of the POI data to which the target word belongs, the method further comprises:
determining a number of the target elements, and
triggering the execution of clustering the location information of some pieces of the POI data to which the target word belongs in response to the number of the target elements being greater than a first number threshold.

20. The storage medium of claim 15, wherein identifying whether the target word is the map regional word according to the clustering result of the location information comprises:
obtaining a number of clustering centers in the clustering result, and
determining the target word as the map region word in response to the number of clustering centers being not greater than a second preset number threshold.
